(19) United States
(12) Patent Application Publication
(10) Pub. No.: US 2007/0191228 A1
(43) Pub. Date: Aug. 16, 2007

(54) Natural herbicide

(76) Inventors: Xiujie Li, Edmonton (CA); Michelle Sulz, Edmonton (CA)

Correspondence Address: NEEDLE & ROSENBERG, P.C., SUITE 1000, 999 PEACHTREE STREET, ATLANTA, GA, 30309-3915, US

(21) Appl. No.: 11/486,929

(22) Filed: Jul. 14, 2006

(30) Foreign Application Priority Data
Jul. 15, 2005 (CA) 2,512,359

(51) Int. Cl. A01N 63/00

(52) U.S. Cl. 504/117

(57) ABSTRACT

A natural herbicide comprising a Burkholderia species cell-free culture fraction having herbicidal activity is provided. The natural herbicide may comprise a cell free fraction having a molecular weight less than about 5000 Daltons, less than 1000 Daltons, or a substantially purified compound having a molecular weight of about 192 Daltons or about 390 Daltons. A method of suppressing or controlling growth of a target plant by applying a composition comprising the natural herbicide is also provided, as is a method of producing a natural herbicide. The natural herbicide may be produced by obtaining a cell-free culture conditioned by growth of a Burkholderia species, fractionating the cell-free culture to obtain a fraction having herbicidal activity, and purifying the fraction having herbicidal activity to produce the natural herbicide.

### FIELD OF INVENTION

The present invention relates to a natural herbicide for suppressing or controlling growth of a target plant. More particularly, the present invention relates to a microbial natural herbicide for suppressing or controlling growth of a target plant.

### BACKGROUND OF THE INVENTION

Weeds cause significant crop yield loss worldwide. Weeds compete with crop plants for nutrition, water and space and may serve as alternate hosts for insect pests or disease agents. In turf grass, weeds also reduce the aesthetic value. Although weed control has been achieved through physical and cultural practices, herbicides remain as a main component of a weed management system.

The widespread use of synthetic chemical herbicides that are not naturally occurring compounds has caused societal and environmental concern. Naturally occurring products are considered to be more environmentally benign than synthetic pesticides due to their natural origin, shorter half-lives, and low rate of the active ingredient (Duke et al., 2000). Therefore, natural herbicides, particularly those shown to be nontoxic to the environment, humans and animals, would be useful in integrated weed-control programs.

A method for identifying bacteria that can control growth of a jointed goatgrass weed in small grain crops under field conditions while avoiding deleteriously affecting the desired small grain crop is disclosed in U.S. Pat. No. 5,163,991 (Kennedy et al.). An alternate method for screening and identifying bacterial strains that can inhibit the growth of the downy brome weed without damaging desired small grain crops is disclosed in CA1,338,904 (Kennedy et al.).

Microbial natural products, especially those produced by plant pathogens are good sources of potential natural herbicides. Several phytotoxins have been discovered (Nakajima et al., 1991; Abbas et al., 1995; and Nakajima et al., 1989). Among them, one nature product, bialaphos, from Streptomyces viridochromogenes, and S. hygroscopicus (Lydon and Duke, 1999) has been developed into a commercial herbicide.

The use of Burholderia andropogonis for controlling the growth of a weed belonging to the order Caryophyllales has been disclosed in US2004/0254075 (Zhang et al.). Furthermore, Zhang et al. show that cell-free culture filtrates of B. andropogonis are effective as a bioherbicide against chickweed.

The application of whole cells to plants is limited by having to maintain cell cultures and inherent ecological uncertainty due to the self-replicating ability of bacteria. Accordingly, there is a need for cell-free compositions derived from microbial sources that have herbicidal activity.

### SUMMARY OF THE INVENTION

The present invention relates to a natural herbicide for suppressing or controlling growth of a target plant. More particularly, the present invention relates to a microbial natural herbicide for suppressing or controlling growth of a target plant.

It is an object of the invention to provide an improved natural herbicide.

According to the present invention there is provided a natural herbicide comprising a Burkholderia species cell-free culture fraction having herbicidal activity and a molecular weight less than about 5000 Daltons. The fraction may have a molecular weight of less than about 1000 Daltons. For example, the fraction may be a substantially purified compound having a molecular weight of about 180 Daltons to about 200 Daltons, or any amount therebetween, for example, but not limited to, a molecular weight of about 192 Daltons (Compound I); or a substantially purified compound having a molecular weight of about 380 Daltons and about 400 Daltons, or any weight therebetween, for example, but not limited to a molecular weight of about 390 Daltons (Compound II); or a mixture of Compound I and Compound II. Compound II may comprises a glycolipid, for example a glycolipid with the formula C₂₀H₃₈O₇. The natural herbicide, Compound I, Compound II, or a combination thereof may be mixed with a suitable adjuvant, for example a surfactant.

The preferred natural herbicide of the present invention is Compound I.

The present invention is directed to the natural herbicide as defined above, wherein the Burkholderia species is Burkholderia andropogonis, isolate CW00B006C.

The present invention also provides a method of suppressing or controlling growth of a target plant comprising applying a composition selected from the group consisting of a natural herbicide as defined above, Compound I, Compound II, and a combination thereof, to the target plant. The target plant may be a member of a genus selected from the group of Taraxacum, Trifolium, Medicago, Companula, Bellis, Plantago, Cynodon, Poa, and Digitaria.

The present invention also pertains to the use of the natural herbicide as defined above, either Compound I or Compound II, or a combination thereof, for suppressing or controlling growth of a target plant. The target plant may be a member of a genus selected from the group of Taraxacum, Trifolium, Medicago, Companula, Bellis, Plantago, Cynodon, Poa, and Digitaria.

The present invention is directed to the natural herbicide as defined above, produced by a process of obtaining a cell-free culture conditioned by growth of a Burkholderia species, and fractionating said cell-free culture to obtain a size fraction having herbicidal activity.

The present invention also provides a method of producing a natural herbicide comprising, obtaining a cell-free culture conditioned by growth of a Burkholderia species, fractionating the cell-free culture to obtain a fraction having herbicidal activity, and purifying the fraction having herbicidal activity to produce the natural herbicide. Preferably, the Burkholderia species is Burkholderia andropogonis isolate CW00B006C.

The present invention provides a natural product produced by Burholderia andropogonis CW00B006C deposited at the ATCC as PTA-4234, May 21, 2002.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows the Mass Spectra Chromatogram of Compound I, produced by the bacterium Burkholderia andropogonis strain CW00B006C, as determined using electron spray ionization mass spectrometry in accordance with an embodiment of the present invention; since the mass is Molecular weight +1 (H), the molecular weight for Compound I is about 192 Da.

FIG. 2 shows systemic effect disease symptoms on chickweed (Stellaria media) seedlings caused by Compound I under laboratory conditions in accordance with a further embodiment of the present invention; Bottom, 6.25% solution of 10× cell free culture filtrates; middle, 6.25% solution of 10× Compound I, and Top, distilled water;

FIG. 3 shows contact effect symptoms on dandelion (Taraxicum officinale) leaves caused by Compound II in accordance with a further embodiment of the present invention; A, water, B, HS medium, C, Compound I, and D, Compound II;

FIG. 4 shows suppression of weeds by Compound I and 0.15% Silwet L-77 under greenhouse conditions in accordance with a further embodiment of the present invention (Left—control, right—treatment); Weeds tested, white clover (Trifolium repens) (FIG. 4A), chickweed (Stellaria media) (FIG. 4B), dandelion (Taraxacum officinale) (FIG. 4C) and crabgrass (Digitaria spp.) (FIG. 4D);

FIG. 5 shows, under field conditions, disease symptoms on dandelion (Taraxacum officinale) seedlings 7 days after treatment caused by 10× cell free culture filtrates produced by the bacterium Burkholderia andropogonis, isolate CW00B006C in accordance with a further embodiment of the present invention; FIG. 5A shows seedlings treated with 10× cell free culture filtrates, FIG. 5B shows seedlings treated with Killex (Green Cross Killex Concentrate, Scotts Canada Ltd.), and FIG. 5C shows seedlings of the control treatment (no spray);

FIG. 6 shows a comparison of average percent phytotoxicity (0-100%, where 100% equals a dead plant) on dandelion (Taraxacum officinale) seedlings treated with 10× cell free culture filtrates produced by the bacterium Burkholderia andropogonis isolate CW00B006C (diamond), Killex (Green Cross Killex Concentrate, Scotts Canada Ltd.) (triangle) and a no spray control treatment (square) at 0-21 days after treatment under field conditions in accordance with a further embodiment of the present invention;

FIG. 7 shows a comparison of average dry weight of dandelion (Taraxacum officinale) seedlings 21 days after treatment with 10× cell free culture filtrates produced by the bacterium Burkholderia andropogonis isolate CW00B006C6 (horizontal stripes), Killex (Green Cross Killex Concentrate, Scotts Canada Ltd.) (vertical stripes) and a no spray control (solid) under field conditions in accordance with a further embodiment of the present invention.

### DETAILED DESCRIPTION

The present invention relates to a natural herbicide for suppressing or controlling growth of a target plant. More particularly, the present invention relates to a microbial natural herbicide for suppressing or controlling growth of a target plant.

The following description is of a preferred embodiment.

An aspect of the present invention pertains to a natural herbicide comprising a natural cell-free product originally derived from a microbial source, for example, and without limitation, a Burkholderia species. A natural herbicide may be produced by any conventional means including, but not limited to, chemical synthesis, overproduction in the original source organism, or production in a microbial or any other organism different than the original source organism. An example, which is not to be considered limiting of the present invention pertains to a natural herbicide comprising an extract, a partially purified extract, or one or more than one compound obtained from Burholderia andropogonis CW00B006C deposited at the ATCC as PTA-4234, May 21, 2002.

In an example of the present invention, the natural herbicide may be derived from a bacterial culture. Compounds having herbicidal activity may be obtained from cell-free cultures that have previously been conditioned by bacterial growth. The cell-free cultures may be concentrated. Furthermore, it has been found that the cell-free cultures may be processed to isolation, substantial purity, or partial purity while still maintaining an ability to suppress or control growth of a target plant. In an example, a natural herbicide may comprise a herbicidal compound that is isolated or substantially purified from a cell-free culture conditioned by prior bacterial growth and having a molecular weight of about 180 Daltons to about 200 Daltons, or any amount therebetween, for example, a molecular weight of any of about 181, 182, 183, 184, 185, 186, 187, 188, 189, 190, 191, 192, 193, 194, 195, 196, 197, 198 and 199 Daltons. Preferably the molecular weight of the isolated or substantially purified natural herbicide is about 192 Daltons (Compound I). In another example, a natural herbicide may comprise a herbicidal compound that is isolated or substantially purified from a cell-free culture conditioned by prior bacterial growth and having a molecular weight of about 380 Daltons to about 400 Daltons, or any amount therebetween, for example, a molecular weight of any of about 381, 382, 383, 384, 385, 386, 387, 388, 389, 390, 391, 392, 393, 394, 395, 396, 397, 398 and 399 Daltons. Preferably the molecular weight of the isolated or substantially purified natural herbicide is about 390 Da (Compound II). Compound II may comprises a glycolipid, for example, but not limited to, a glycolipid with the formula C₂₀H₃₈O₇.

Another aspect of the present invention pertains to a method for suppressing or controlling growth of a target plant comprising applying an effective dose of a natural herbicide, for example but not limited to Compound I, Compound II, or a combination thereof, of the present invention to the target plant. A target plant will typically be a weed, for example, without limitation, dandelion (Taraxacum officinale), white clover (Trifolium repens), black medic (Medicago lupulina), bellflower (Companula rapunculoides), English daisy (Bellis perennis), plantain (Plantago spp.), Bermuda grass (Cynodon dactylon), annual blue grass (Poa annua), and crabgrass (Digitaria spp.). However, other target plants may also be treated with the natural herbicide of the present invention.

By “natural herbicide” is meant a natural product, metabolite, or fraction, originally derived from a microbial organism, typically a plant pathogen, that reduces the growth rate, development, or both the growth rate and development (for example, without limitation, as evidenced by reduced dry weight), possibly leading to death, of at least one target plant species. In one example, a natural herbicide of the present invention may exhibit selective activity when applied to one or more target plants, so that a plant of interest is less susceptible to the effects of the natural herbicide compared to one or more target plants. In another example, selective activity is such that a plant of interest is not substantially affected by the natural herbicide, while one or more target plants, for example a weed species is susceptible to the effects of the natural herbicide. Non limiting examples of a natural herbicide of the present invention include one or more than one fraction obtained from cell-free culture conditioned by prior bacterial growth, a herbicidal compound having a molecular weight of about 192 Da (Compound I), a herbicidal compound having a molecular weight of about 390 Da (Compound II), or a combination thereof.

By “plant of interest” is meant a plant species for which growth is desired compared to a target plant. Plants of interest may include horticulturally and agriculturally important species. Without wishing to be limiting, a plant of interest may be selected from the group consisting of crops including but not limited to wheat (Triticum aestivum), alfalfa (Medicago sativa), and common turf grass species including but not limited to Kentucky blue grass (Poa pratensis), Tall fescues (Festuca arundinasea schreb) Creeping red fescue (Festuca rubra) and perennial ryegrass (Lolium perenne). However, it is to be understood that any other plant of commercial interest may be considered a plant of interest provided that it is not more susceptible than a target plant to the effects of a natural herbicide of the present invention. These plants may include, but are not limited to barley, corn, soybean, canola, other food plants, horticultural plants, potted plants, garden plants and grasses.

By “target plant” it is meant a plant for which growth is not desired and which is susceptible to the effects of a natural herbicide, exhibiting, for example, reduced growth, abnormal development or death when exposed to the natural herbicide. Target plants are typically weed species, for example but not limited to dandelion (Taraxacum officinale), white clover (Trifolium repens), black medic (Medicago lupulina), bellflower (Companula rapunculoides), English daisy (Bellis perennis), plantain (Plantago spp.), Bermuda grass (Cynodon dactylon), annual blue grass (Poa annua), and crabgrass (Digitaria spp.).

The term “suppression” is used as defined by the Pest Management Regulation Agency (PMRA, Regulatory Directive 93-07B, Agriculture and Agrifood Canada, Food Production and Inspection Branch, Plant industry Directorate, Apr. 5, 1993). By the term “suppression” (or “partial control”), it is meant a minimum of 60% reduction in the growth of a target plant, or a minimum of 60% reduction of in weed stand, when compared with an untreated control. For example, a reduction in the growth of a target plant from about 60% to about 80%, or any amount therebetween, including 60, 62, 64, 66, 68, 70, 72, 74, 76, 78, and 80%, or any amount therebewteen. The term “control” is used as defined by the PMRA. By the term “control” (in the context of controlling the growth of a target plant) it is meant a minimum of 80% reduction in the growth of a target plant, or a minimum of 80% reduction of in weed stand, when compared with an untreated control. For example, a reduction in the growth of a target plant from about 80% to about 100%, or any amount therebetween, including 80, 82, 84, 86, 88, 90, 92, 94, 96, 98, and 100%, or any amount therebetween. Weed control measurement can take the form of visual observations, actual weed counts per given area (stand) or measurements of weed height, vigor, or weight.

The natural herbicide of the present invention may be combined with any other compound or agent in order to formulate a composition that is effective to suppress or control a target plant. For example, efficacy or applicability of a natural herbicide may be enhanced by combination with an additional herbicide, including an additional natural or synthetic herbicide, or an adjuvant including, without limitation, a surfactant, crop oil, methylated seed oil, wetting agent, or fertilizer. Without wishing to be bound by theory, an adjuvant may improve the action of a natural herbicide by one or more known mechanisms, for example, enhancing transport into a plant, improving stickiness to a leaf surface, changing osmotic potential, or enhancing plant uptake. Many adjuvants are currently commercially available for combining with herbicides. Both the natural herbicide alone or in combination with an adjuvant will typically be formulated to safe for a plant of interest, while providing effective suppression or control of a target plant.

Other compounds or agents that may be combined with a natural herbicide of the present invention include, without limitation, other active agents, compounds that alter viscosity of a solution, glycols, controlled release agents, anti-freeze agents, dyes, anti-foaming agents, UV stabilizers, humectants, preservatives or pH adjusting agents.

Surfactants are a class of adjuvant often used in herbicide formulations. A surfactant may enhance efficacy of a natural herbicide, facilitate application of the natural herbicide, or do both. Various surfactants of non-ionic, cationic, anionic or amphoteric nature are known. For example, U.S. Pat. No. 6,887,830 (Stridde et al., which is incorporated herein by reference) describes several examples of amine-based or sulfosuccinamate-based surfactants. Surfactant mixtures are typically formulated to have one or more of good emulsifying, dispersing or wetting properties. In a non-limiting example of the present invention, a natural herbicide from a bacterial source is combined with a Silwet L-77 surfactant.

A natural herbicide may be applied to plants using conventional methods for applying herbicides, for example, without limitation, using spraying of liquid formulations or spreading of solid formulations. The rate of application of a herbicide composition can depend on a number of factors including, for example, the active ingredients chosen for use, the identity of the, plants whose growth is to be inhibited or whether a formulation is to be applied for foliage or root uptake. In general and not to be considered limiting, an application rate of from 0.001 to 20 kilograms per hectare, or any amount therebetween, may be appropriate.

In an aspect of the present invention, a natural herbicide may comprise a fully isolated, substantially or partially purified fraction of a cell-free culture medium conditioned by bacterial growth. Accordingly, a natural herbicide may comprise one or more than one natural compound having herbicidal activity. Furthermore, a natural herbicide of the present invention may have one or more than one type of activity. For example, which is not to be considered limiting, a natural herbicide may be one or more of a broad-spectrum herbicide, a selective herbicide, a pre-emergence herbicide, a post-emergence herbicide, a systemic herbicide, or a contact herbicide.

A systemic herbicide is typically a mobile herbicide that can translocate from the site of application to have a herbicidal effect at a site distant from the site of application. Examples of a systemic herbicidal effect include, but are not limited to, stunting, chlorosis of new growth or small distorted new leaves. A contact herbicide is typically a non-mobile herbicide with the herbicidal effect being primarily at the site of application. Examples of a contact herbicide effect include, but are not limited to, necrosis or death of old leaves. An isolated or substantially purified compound or a partially purifed fraction may possess systemic, contact or both systemic and contact effects. In an example of the present invention, a natural herbicide is shown to be a contact herbicide. In another example, a natural herbicide is shown to be a systemic herbicide. In yet another example, a natural herbicide is shown to be both a systemic and a contact herbicide.

An aspect of the present invention pertains to a natural herbicide comprising a fully isolated, substantially purified, or partially purified fraction of a bacterial cell-free culture. As described herein, herbicidal activity has been identified to reside within a culture medium conditioned by prior bacterial growth. Furthermore, the bacterial cell-free culture may be concentrated, purified, or both concentrated and purified while still maintaining herbicidal activity. In one example, a natural herbicide may comprise a Burkholderia species cell-free culture fraction having a molecular weight of less than about 10000, 9000, 8000, 7000, 6000, 5000, 4000, 3000, 2000, 1000 Da or less, or any weight therebetween or less. In another example, a natural herbicide may comprise a Burkholderia species cell-free culture fraction having a molecular weight of greater than about 1000 Da and less than about 10000, 9000, 8000, 7000, 6000, 5000, 4000, 3000, 2000 Da, or any weight therebetween. For example, the Burkholderia species cell-free culture fraction may comprise a molecular weight of from about 1000 to about 3000 Da, or any weight therebetween. In another example, a natural herbicide may comprise a Burkholderia species cell-free culture fraction having a molecular weight of greater than about 10 Da and less than about 1000, 900, 800, 700, 600, 500, 400, 300, 200, 100 Da, or any weight therebetween. In yet another example, a natural herbicide may comprise a compound of about 192 Da substantially purified from a Burkholderia species cell-free culture. In yet another example, a natural herbicide may comprise a compound of about 390 Da substantially purified from a Burkholderia species cell-free culture. In yet another example, a natural herbicide may comprises a glycolipid with the formula C₂₀H₃₈O₇.

Conventional purification or fractionation methods may be used to obtain a fully isolated or substantially purified herbicidal compound or partially purified herbicidal fraction from cell-free bacterial cultures. Typical methods include, without limitation, size exclusion or ion exchange chromatography, ammonium sulfate, alcohol, or chloroform extraction, or centrifugation with size filters.

Efficacy of a natural herbicide of the present invention may be established using any convenient testing method. Typically, assessment of a herbicide treated target plant is expressed as a comparison with an untreated control. Furthermore, a natural herbicide treatment may be compared against a recognized commercial treatments such as Killex (Green Cross Killex Concentrate, Scotts Canada Ltd.) or Premium 3-Way (PCP#18948, IPCO, Saskatoon). Any convenient method may be used to test for efficacy of a natural herbicide, and the particular method is not critical to the present invention. Assessment of a natural herbicide treatment may be accomplished, for example, without limitation, by qualitative visual observation, plant count per given area, or measurement of leaf number, plant height, diameter, vigor, or weight. Quantified results are typically expressed as a percentage of a control treatment. Similar tests may be carried out with respect a plant of interest in order to determine whether a natural herbicide may have an adverse effect on the plant of interest. In this regard, assessment of a plant of interest by plant count, yield, or weight may be useful.

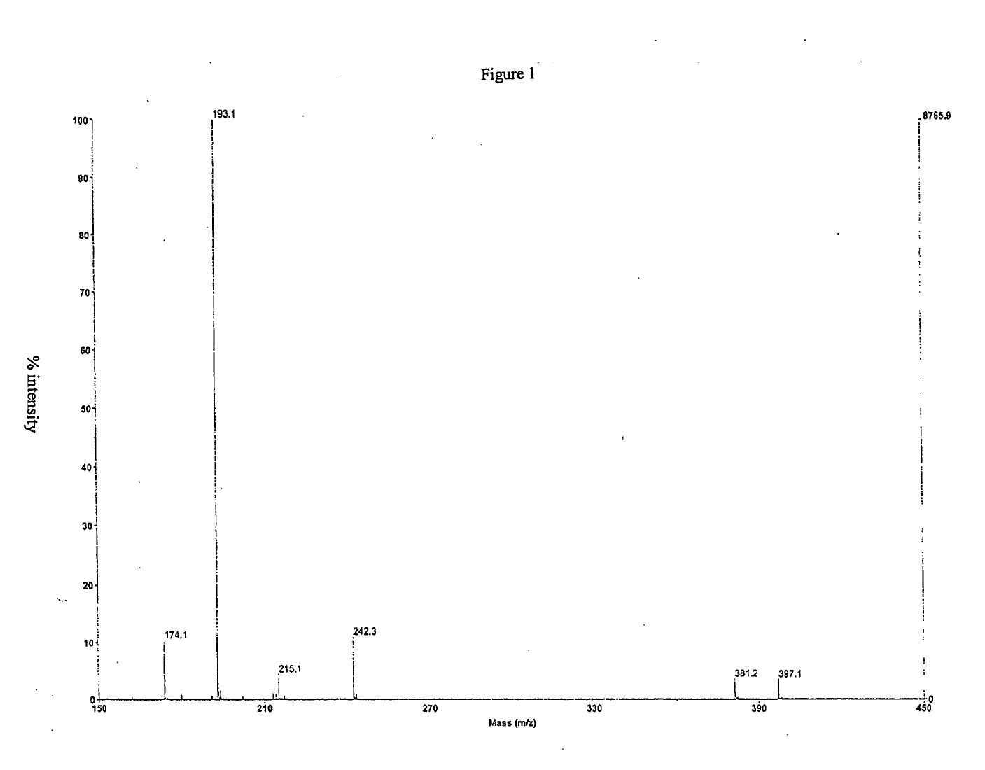

Referring now to FIG. 1, and as described in more detail in Example 2, there is shown the analysis of a purified natural herbicide isolated from a cell free culture filtrate of Burkholderia. The purified compound exhibits a single peak at 193.1 m/z of the electron spray ionization mass spectrometry chromatography indicating that a natural herbicide compound purified from a Burkholderia andropogonis cell-free culture has a molecular weight of about 192 Da (referred to as “Compound I”).

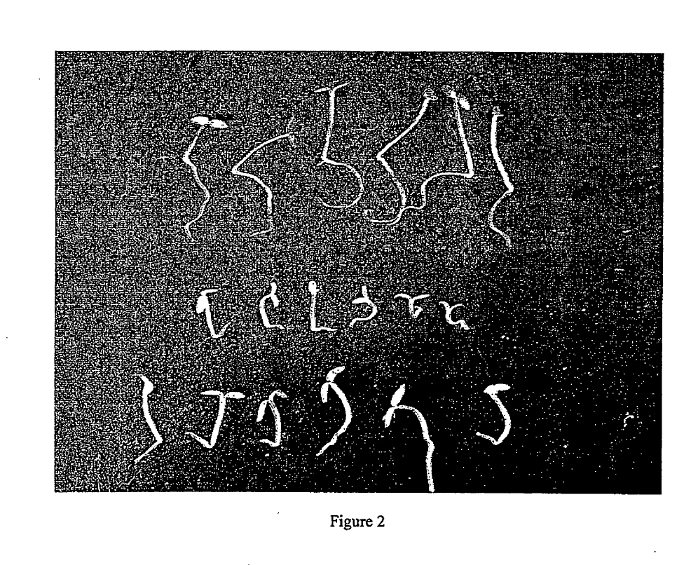

Referring now to FIG. 2, there is shown the systemic effect of a natural herbicide produced by Burkholderia andropogonis strain CW00B006C on chickweed (Stellaria media) seedlings in a laboratory bioassay. Seedlings treated with the natural herbicide solutions display varying degrees of foliar chlorosis and purple stems. Further, as indicated in Table 1 of example 3, seedlings treated with a 6.25% solution of 1× cell-free culture filtrate of isolate CW00B006C or a 0.625% solution of 10× cell free culture filtrates or LPLC purified Compound I, show substantial inhibition of root growth in comparison to the root length of control seedlings treated with tap water. As suggested by the result of FIG. 2, Compound I causes a systemic herbicidal effect.

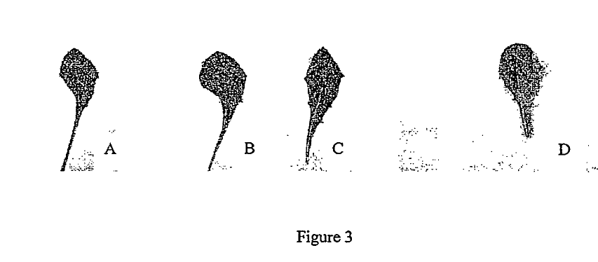

Referring now to FIG. 3, there is shown the symptoms caused by a natural herbicide produced by Burkholderia andropogonis strain CW00B006C on a dandelion (Taraxacum officinale) leaf treated with Compound II. The leaf shown in FIG. 3D is treated with Compound II. As suggested by the result of FIG. 3, Compound II causes a contact herbicidal effect.

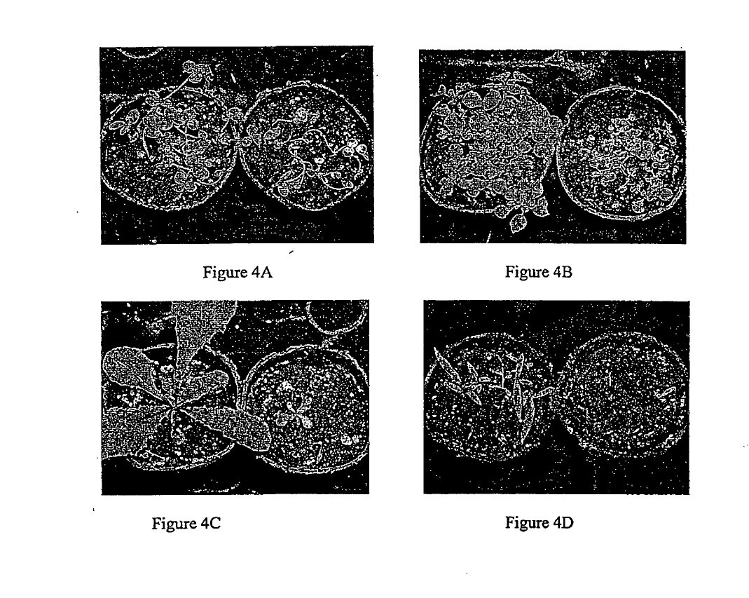

Referring now to FIG. 4, there is shown the effect of an exemplary natural herbicide (Compound I and 0.15% Silwet L-77) on white clover (Trifolium repens), (FIG. 4A), chickweed (Stellaria media), (FIG. 4B), dandelion (Taraxacum officinale) (FIG. 4C) and crabgrass (Digitaria spp.) (FIG. 4D). Further as indicated in example 4, a dry weight reduction of 61.06%, 61.80%, 68.95%, and 76.48% was caused on white clover (Trifolium repens), black medic (Medicago lupulina), chickweed (Stellaria media), and dandelion (Taraxacum officinale) respectively.

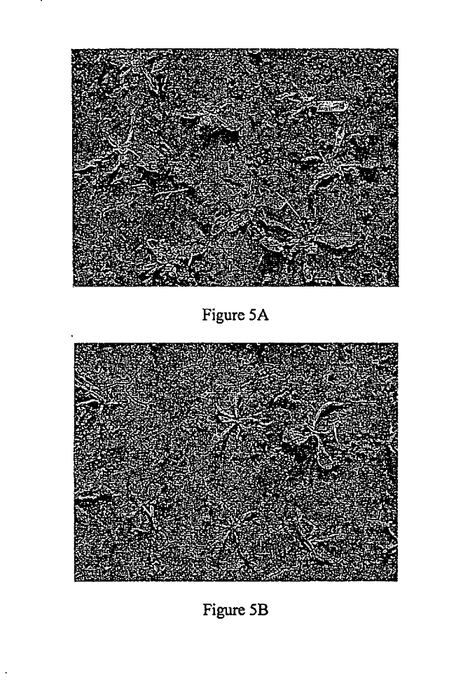

Referring now to FIG. 5, there is shown the effect of a natural herbicide on suppression of dandelion seedlings (Taraxacum officinale), when sprayed at a 10× concentration cell free culture filtrates produced by Burkholderia andropogonis strain CW00B006C, under field conditions. The plants shown in FIG. 5A are treated with the natural herbicide, the plants shown in FIG. 5B are treated with a commercial herbicide Killex (Green Cross Killex Concentrate, Scotts Canada Ltd.); and the plants in FIG. 5C are control treatment with no spray. Results indicate that the natural herbicide causes necrosis and death of old leaves (contact effect), stunting, chlorosis of new growth and small distorted new leaves (systemic effect).

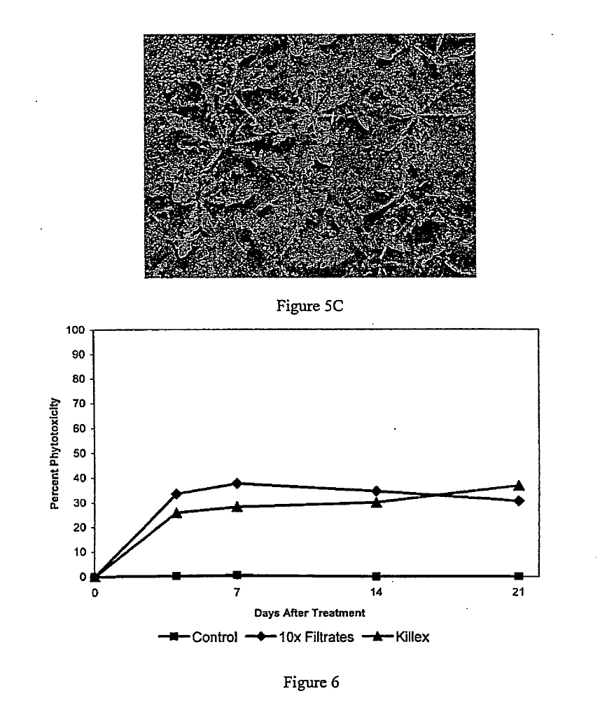

Referring now to FIG. 6, there is shown the phytotoxicity of a natural herbicide produced by the bacterium Burkholderia andorpogonis when sprayed as 10× cell free culture filtrates with addition of 0.15% Silwet L-77 on dandelion (Taraxacum officinale) seedlings under field conditions. The results indicate that the natural herbicide formulation cause similar phytotoxicity compared to the commercial herbicide Killex (Green Cross Killex Concentrate, Scotts Canada Ltd.).

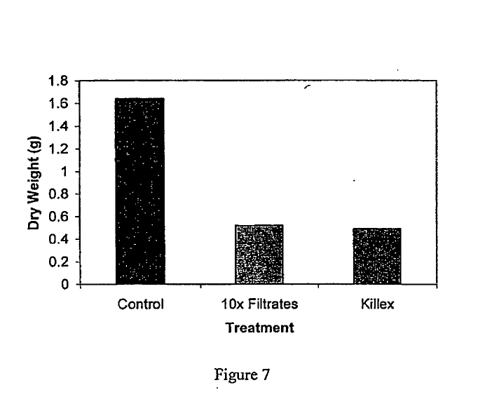

Referring now to FIG. 7, there is shown that a natural herbicide produced by the bacterium Burkholderia andropogonis when sprayed as 10× cell free culture filtrates with addition of 0.15% Silwet L-77 (v/v) under field conditions, reduced by 68% the dry weight of dandelion (Taraxacum officihale) seedlings whereas the commercial herbicide Killex (Green Cross Killex Concentrate, Scotts Canada Ltd.) reduced by 70% the dry weight of dandelion (Taraxacum officinale) seedlings. This result suggests that the 10× cell free culture filtrates may be employed as a weed control agent for, but not limited to, dandelion (Taraxacum officinale).

A dose response experiment has shown that Compound I with no surfactant causes chlorosis stunting and mortality of dandelion (Taraxacum officinale) and crabgrass (Digitaria spp.) seedlings under greenhouse conditions. The dry weight of dandelion (Taraxacum officinale) and crabgrass (Digitaria spp.) 21 days after treatment was reduced by 64.59% and 92.09% respectively with no significant (P 0.05) impact on Kentucky blue grass when Compound I was applied at 40× the original filtrate concentration suggesting that Compound I may be employed to control weeds for example, but not limited to dandelion (Taraxacum officinale) and crabgrass (Digitaria spp.) in turf (see Table 2 Example 6).

Theses results show that a concentrate of the cell-free culture filtrate of the bacterium Burkholderia andropogonis isolate CW00B006C, Compound I or II with or without a surfactant such as Silwet L-77 (v/v), or the combination of Compound I and Compound II may be used in a method for the suppression or control of a target plant, for example, but not limited to white clover (Trifolium repens), chickweed (Stellaria media), dandelion (Taraxacum officinale) black medic (Medicago lupulina) and crabgrass (Digitaria spp.).

Host specificity is a criteria in the selection of a suitable natural herbicide. The natural product produced by Burkholderia andropogonis used as 10× cell free culture filtrates or the combination of Compound I and Silwet L-77 were safe to most turf grass species. 10× cell free culture filtrates cause no damage to turf grass species, for example but not limited, to Kentucky blue grass (Poa pratensis), Perennial ryegrass (Lolium perenne), Tall fescue (Festuca arundinasea), and Creeping red fescue (Festuca rubra var Boreal). Slight damage to creeping red fescue (Festuca rubra var Jasper), and bentgrass (Agrostis tenuis), occurred. Most 10× cell free culture filtrates treatments caused less impact than the commercial turf grass herbicide, Premium 3-Way (PCP# 18948, IPCO, Saskatoon) except for one bantgrass variety Cata (see Table 1, Example 4). The dry weight of dandelion treated with 10× cell free culture filtrates included as a positive control was reduced by 66.9%.

Compound I with the surfactant Silwet L-77 had no impact on common turf grass species for example but not limited to Kentucky blue grass (Poa pratensis), fescues (Festuca spp.) and perennial ryegrass (Lolium perenne) (Table 2, Example 4). Slight yellowing of bentgrass (Agrostis) was observed four days after treated with Compound I (10-20% phytotoxicity) but symptoms were no longer evident after one week and there was no impact on the dry weight of bent grass collected 14 days after treatment. This result suggests that Compound I alone, or in combination with Silwet L-77 is safe as natural herbicide for suppression or control of weeds in common turf grass species (see Table 2, Example 4).

The present invention will be further illustrated in the following examples.

### EXAMPLES

### Example 1

### Production of Herbicidal Compounds

A working seed culture cryovial of Burkholderia andropogonis, isolate CW00B006C, was warmed to room temperature in a 36° C. water bath. A 1 ml aliquot of solution was transferred to each 250 ml Erlenmeyer flask containing 75 ml Nutrient Glucose Broth (Hoitinic and Sinden, 1970). Flasks were incubated on an orbit shaker for 24 hrs at 200 rpm under ambient lab condition (24±3° C.) and used as seed inoculum for 2 L Erlenmeyer flasks each containing 600 ml of filter-sterilized Hoitink-Sinden (Hoitink and Sinden, 1970) medium modified to contain 1 ml/L Trace Elements Solution HO-LE (Parks, 1993). Hoitink-Sinden (HS) cultures were incubated on an orbit shaker at 200 rpm for 4-6 days at 24±3° C. Contents of flasks were combined and centrifuged for 10 minutes at 22,500 rcf (Sorvall RC-5B superspeed refrigerated centrifuge) to pellet bacterial cells. Supernatant was collected and passed through a Nalgene 0.22 μm PES bottle-top vacuum filter to remove all remaining bacteria cells and debris. Cell-free culture filtrates were stored at 4° C. until use.

To produce concentrated (10× to 20×) cell free culture filtrate, the above cell free culture filtrates were rotoevaporated at 65° C. to one tenth to one twentieth (10× to 20×) the original volume and stored at 4° C. until use.

### Example 2

### Purification and Characterization of the Active Ingredients

Burkholderia andropogonis has been reported to produce rhizobitoxine hydroxythreonine and two other compounds (Mitchell et al., 1986; Mitchell and Frey, 1988). Rhizobitoxine is a colorless (Mitchell et al., 1986) chlorosis-inducing agent also produced by the legume symbiont Bradyrhizobium elkanii (Kuykendall et al., 1992; Owens and Wright, 1965; Owens et al., 1972). The molecular weight of rhizobitoxine was reported as 190 D (Owens et al., 1972). Rhizobitoxine is herbicidal to sorghum (Sorghhum bicolor (L.)) and large crabgrass (Digitaria sanguimalis) (Owens 1973). Three Burkholderia species, B. brasiliensis, B. cepacia, and B. pseudomallei have been reported to produce exopolysaccharide (Mattos et al., 2001, Cérantola et al., 1999; and Cescutti et al., 2000). B. cepacia, and B. pseudomallei are human pathogens (Govan and Deretic, 1996; Steinmetz et al., 2000) while B. brasiliensis is a nitrogen-fixing bacterium isolated from plants (Gillis et al., 1995 and Baldani et al., 1997). Exopolysaccharide is considered to play a role in plant-bacterial interaction and colonization (Leigh and Coplin; 1992).

Purification of Compound I and II

Low pressure liquid chromatography (LPLC) with a strong acid cation exchange resin (Dowex 50WX4-100) was used for laboratory purification of cell-free culture filtrates (Owens and Wright, 1965). A 500 g aliquot of resin was hydrated in deionized water overnight, then poured into a ⅓ water-filled, open-topped glass column (5 cm diameter, 60 cm height) with a frit and stop cock. De-ionized water was passed through the column using a flow rate of 2 ml/minute. A 2-4 L aliquot of cell-free culture filtrates, pH adjusted to 3.8, was then passed through the column at a maximum flow rate of 2 ml/minute. The resin was then washed with 2 L of de-ionized water. The herbicidal compound bound to the resin was then eluted with 0.1 M ammonium hydroxide at a maximum flow rate of 2 ml/minute. The desired fraction, containing the herbicidal Compound I, elutes with a yellow-orange color and a rise in pH to about 10 as indicators of its presence.

The LPLC purified NP6C Bioherbicide was further purified by BioLogic DuoFlow HPLC System. A 1 ml sample, pH adjusted to 3.8 with 1 M HCl, was applied to an Econo-Pac High S ion exchange column (Bio-Rad Laboratories Ltd., Mississauga ON., Canada). After washing the column with distilled water, the sample was eluted with a linear gradient of 0-100% 0.1N NH4OH at 2 ml/min over a period of 30 min followed by 100% 0.1N NH4OH at 2 ml/min for 20 min. The eluent was monitored at 254 nm and fractions were collected every 1 min. All samples were bioassayed for activity in a laboratory bioassay.

Characterization of Compound I

HPLC purified natural herbicide was used for characterization. The molecular weight of the active ingredient of this natural herbicide was determined using electron spray ionization mass spectrometry, which revealed a peak at 193.1 m/z (FIG. 1). Since the mass is Molecular weight +1 (H), the molecular weight for Compound I was about 192 Da. Laboratory bioassay showed this Compound has systemic effect on chickweed (Stellaria media (L) Cyrill) seedlings.

Purification and Characterization of Compound II

The first fraction from the above mentioned cation exchange LPLC was collected and further separated by C18 column. One of the C18 separated fraction showed contact effect herbicidal activity on dandelion leaves treated in laboratory bioassay (Compound II). Further analysis by Mass Spectrometry revealed that the molecular weight of Compound II, was about 390 Da. NMR analysis revealed that Compound II was a glycolipid with the formula of C₂₀H₃₈O₇.

### Example 3

### Laboratory Bioassay of the Active Ingredients

Laboratory bioassays have been developed for assessing herbicidal activity of cell-free culture filtrates, Compound I, Compound II, Compound I and Compound II, or other forms of a natural herbicide produced by Burkholdera andropogonis, isolate CW00B006C.

Sample Preparation

For Compound I (systemic active ingredient) detection, Compound I and Compound II in the formulation of cell-free culture filtrates were diluted to 6.25% for systemic bioassay, while purified Compound I natural herbicide solutions, which had higher herbicidal activity, were diluted to 0.625% and 6.25% prior to bioassay. For Compound II (contact effect active ingredient) detection, Compound II purified from C18 column was used for contact effect bioassay

Bioassay Set Up

For systemic effect testing, each of three replicate glass Petri plates per treatment were fitted with a Whatman No. 1 filter paper and 10 chickweed (Stellaria media L. (Cyrill)) seeds from a single seed source. A 5 ml aliquot of bioassay solution was placed in each Petri plate and plates were sealed and incubated under ambient laboratory conditions (24° C.±3) for 7 days. After 7 days incubation, the root length (mm) of each seedling was measured and visible symptoms, including cotyledon chlorosis and purpling of seedling stems, were assessed. For contact effect testing, healthy dandelion (Taraxacum officinale) leaves were collected from greenhouse plants, punched with a needle to bear 10 holes for easy entry of the testing compounds, and placed onto supporting microscopic slides. Drops (50 μl) of size exclusive column purified Compound II were placed on each punched dandelion (Taraxacum officinale) leaf. The glass slides supporting the treated dandelion (Taraxacum officinale) leaves were placed in a Petri plate lined with Waterman No. 1 filter paper moistened with distilled water and sealed. Herbicidal activity was indicated by necrosis and cell death 48 hrs after treatment. Water was used for the control treatment.

Results

Germination of chickweed (Stellaria media (L) Cyrill) seedlings in Compound I (systemic) laboratory bioassays was generally 40-70%. Germinated seedlings treated with 6.25% cell-free culture filtrates of isolate CW00B006C or a 0.625% solution of crude (10× Filtrates) or Compound I, showed substantial inhibition of root growth in comparison to the root length of control seedlings (Table 1). Seedlings treated with the herbicide solutions also displayed varying degrees of chlorosis and purple stems (FIG. 2). When a very high concentration of herbicide was present, the bioassay results were non-linear and it was therefore important to include two dilutions (6.25% and 0.625%) of herbicidal solution when high activity is expected.

Compound II (contact effect) bioassay results demonstrated varying degrees of necrosis and cell death on dandelion (Taraxacum officinale) leaves 48 hrs after treatment. Compound II resulted in clear symptoms (FIG. 3D) while Compound I and the control caused no visible symptoms.

TABLE 1
Systemic laboratory bioassay results for cell free culture filtrates,
10x cell-free culture filtrates, Compound I and a control (tap water)
solutions. Average root length of germinated chickweed
(Stellaria media (L) Cyrill) seedlings, as well as disease
symptoms, were assessed after 7 days.

| | Average Root | | | |
|---|---|---|---|---|
| | Length (mm) | | Disease Symptoms** | |
| | 0.625% | 0.625% | 0.625% | 0.625% |
| Herbicidal Solution | Solution | Solution | Solution | Solution |
| Cell-free Culture Filtrates | — | 7.10* | — | 2.41 |
| 10x Filtrates | 6.50 | 3.80 | 1.32 | 2.57 |
| Compound I | 6.17 | 4.67 | 1.67 | 2.33 |
| Control | — | 42.00 | — | 0 |

*Value is the average for 8 bioassays each representing a 15L batch of isolate CW00B006C culture. Values for natural herbicide solutions and the control are from one, representative, bioassay.
**Seedling disease symptoms are assessed using a 0-6 scale where:
0 = seedling has green leaves, healthy;
1 = yellow leaves with green tips;
2 = yellow-green leaves;
3 = yellow-white leaves;
4 = yellow-green leaves, purple stem;
5 = white-yellow leaves, purple stem;
6 = white leaves, purple stem.

### Example 4

### Efficacy on the Target Weeds

Various greenhouse experiments were conducted to test the efficacy of several natural herbicides comprising Compound I on some of the economically important weeds. Weeds species tested included dandelion (Taraxacum officinale), chickweed (Stellaria media), white clover (Trifolium repens) black medic (Medicago lupulina), bellflower (Companula rapunculoides), English daisy (Bellis perennis), plantain (Plantago spp.), Bermuda grass (Cynodon dactylon), annual blue grass (Poa annua), and crabgrass (Digitaria spp.).

Plant Production

Seeds were sown in 10 cm diameter peat pots containing Sunshine Growing Mix #1 (SunGro Horticulture Canada Ltd., Seba Beach, Alberta, Canada) or Steam-pasteurized soil mix containing loam soil, sand, Sunshine Growing Mix (SunGro Horticulture, Bellevue, Wash. 98008), Fibrous Blond Sphagnum Peat Moss (Premier Pro Moss, 1 Premier Avenue, Riviere-du-Loup, Quebec, Canada), Vermiculite (Therm-O-Rock, 6732 W. Willis Road #5014, Chandler, Ariz. 85226), dolomite lime, and Super Phosphate. Seeded pots were placed in a greenhouse with 23/20±4° C. day/night temperature, a 16 h photoperiod, an average light intensity of 300 μEm⁻²s⁻¹, and an average humidity of 45-50%. After germination, weed seedlings were thinned to 1-5 plants per pot, depending on the species. All plants were at the seedling stage of growth at the time of spray application.

Treatments

Treatments included Compound I plus Compound II, Compound I alone, and Compound I amended with 0.15% (v/v) Silwet L-77. A no spray treatment was included as a control treatment. Also, a commercial chemical herbicide, Premium 3-Way (PCP#18948, IPCO, Saskatoon) was selected as a comparison to the natural herbicide.

Measurements

Plants in each replicate pot were assessed at 1, 4, 7, and 14 days after treatment (DAT) for percent phytotoxicity (0-100% in 10% increments). Dry weight of aboveground biomass per pot was determined 14 or 28 DAT depending on the treatments.

Results

Natural herbicides suppressed or controlled white clover (Trifolium repens L) (FIG. 4A), chickweed (Stellaria media (L) Cyrill) (FIG. 4B), dandelion (Taraxicum officinale weber) (FIG. 4C), and crabgrass (Digitaria spp) (FIG. 4D). Symptoms varied slightly with the weed species but included varying degrees of chlorosis, necrosis, leaf distortion and stunting of plants. No significant suppression of Canada thistle was achieved with the natural herbicide. Dry weight reductions of 61.06%, 61.8%, 68.95%, 72%, 76.48% and 92.09% were achieved on white clover, black medic, chickweed, Bermuda grass, dandelion and crabgrass respectively.

### Example 5

### Turf Grass Safety

Both Compound I, and Compound I plus Compound II in the formulation of 10× cell-free culture filtrates were used to test the safety of the natural herbicide to turf grass species.

Common cool season turf grass species such as tall fescue (Festuca arundinasea var. Tallisman and Crossfire), perennial ryegrass (Lolium perenne var Fiesta III and Low Grow), Kentucky blue grass (Poa pratensis var. Quantum leap and Limousine), creeping red fescue (Festuca rubra var. Boreal and jasper), bentgrass (Agrostis tenuis var. Cata and A-4) and creeping bentgrass (Agrostis palustris var Penncross) were selected for testing.

Plant Production

Turf grass seeds were sown in 10 cm diameter peat pots containing steam-pasteurized soil mix containing loam soil, sand, Sunshine Growing Mix (SunGro Horticulture, Bellevue, Wash. 98008), Fibrous Blond Sphagnum Peat Moss (Premier Pro Moss, 1 Premier Avenue, Riviere-du-Loup, Quebec, Canada), Vermiculite (Therm-O-Rock, 6732 W. Willis Road #5014, Chandler, Ariz. 85226), dolomite lime, and Super Phosphate. Seeded pots were placed in a greenhouse with 23/20±4° C. day/night temperature, a 16 h photoperiod, an average light intensity of 300 μEm⁻²s⁻¹, and an average humidity of 45-50%. Turf grass was sprayed approximately 14 days after seeding.

Treatments

Treatments included Compound I plus Compound II, or Compound I alone. No spray was used as a control treatment. Also, a commercial chemical herbicide Premium 3-Way was selected as a comparison to the natural herbicide. All treatments were applied with an automatic overhead sprayer on a spray cabinet using a SS11008 Teejet nozzle at an application rate 1000 L/ha.

Measurement

Plants in each replicate pot were assessed at 1, 4, 7, 14, 21, and 28 DAT for percent phytotoxicity (0-100% in 10% increments). Dry weights of above ground biomass per pot were determined 28 DAT.

Results

The tested natural herbicides caused no damage to Kentucky blue grass (Poa pratensis), Perennial ryegrass (Lolium perenne), Tall fescue (Festuca arundinasea), and creeping red fescue (Festuca rubra var. Boreal). Slight damage to creeping red fescue (Festuca rubra var. Jasper), and bentgrass (Agrostis tenuis), occurred with Compound I plus Compound II treatment. Slight damage to creeping red fescue (Festuca rubra var. Jasper) and bentgrass (Agrostis tenuis var. Cata) occurred with Compound I treatment. Natural herbicide treatments showed less impact than the commercial turf grass herbicide Premium 3-Way, except for one Bantgrass variety (Agrostis tenuis var. Cata) (Table 2).

TABLE 2
Dry weight reduction of turf grass species in comparison to a no spray
control 4 weeks after treatment with Compound I, or Compound I
plus Compound II produced by Burkholderia andropogonis
isolate CW00B006C, or the commercial herbicide Premium 3-Way

| | | Treatments | | |
|---|---|---|---|---|
| | | Compound I | | |
| | | plus | | Premium 3- |
| Weeds | | Compound II | Compound I | Way |
| species | Varieties | Dry Weight Reduction (%) | | |
| Tall | Talisman | 0 | 0 | 13.1 |
| Fescue | Crossfire | 0 | 0 | 24.1 |
| Perennial | Fiesta III | 2.5 | 0 | 14.9 |
| ryegrass | Low Grow | 0 | 0 | 0 |
| Kentucky | Limousine | 0.8 | 0 | 12.4 |
| blue | Quantum | 6.3 | 0 | 48.3 |
| grass | Leap | | | |
| Creeping | Boreal | 9.1 | 0 | 32.7 |
| red | Jasper | 30.5 | 23.81 | 52.5 |
| fescue | | | | |
| Bentgrass | Cata | 56.1 | 29.48 | 46.5 |
| | A-4 | 34.5 | 0 | 37.2 |
| Creeping | Penncross | 22.9 | 0 | 27.9 |
| bent | | | | |
| grass | | | | |

### Example 6

### Dose Response

Application of pest control products at the lowest effective rate (also referred to as “minimum effective dose”) is an important means of achieving sustainable pest management objectives, avoiding or delaying resistance development, and avoiding unintentional effects on workers, bystanders, or the environment. An experiment was conducted to determine the level of dandelion (Taraxacum officinale Weber) and crabgrass (Digitaria spp) suppression or control provided by the natural herbicide of the present invention with variation in the application rate and volume. The safety of each formulation to turf grass using Kentucky blue grass (var Quantum Leap), was also tested.

Plant Production

Seeds were sown in 10 cm diameter peat pots containing steam-pasteurized soil mix containing loam soil, sand, Sunshine Growing Mix (SunGro Horticulture, Bellevue, Wash. 98008), Fibrous Blond Sphagnum Peat Moss (Premier Pro Moss, 1 Premier Avenue, Riviere-du-Loup, Quebec, Canada), Vermiculite (Therm-O-Rock, 6732 W. Willis Road #5014, Chandler, Ariz. 85226), dolomite lime, and Super Phosphate. Seeded pots were placed in a greenhouse with 23/20±4° C. day/night temperature, a 16 h photoperiod, an average light intensity of 300 μEm⁻²s⁻¹, and an average humidity of 45-50%. After germination, weed seedlings were thinned to 3 plants per pot. Dandelion (Taraxacum officinale Weber) seedlings were at the 4-5 true leaf growth stage, while crabgrass (Digitaria sanguinalis) seedlings were at 2-3 leaf stage at the time of spray application.

Treatments

Treatments included Compound I at a concentration of 10×, 20×, and 40× of LPLC purified solution as described previously in Example 2; Compound I plus Compound II in the formulation of cell-free culture filtrates was applied at a concentration of 10×, 12.5×, 15×, 17.5× and 20×. The pH of the LPLC solution was adjusted to 6.0. 800 L/ha and 1600 L/ha were selected as application rates. All spray applications were performed with an automatic overhead sprayer on the spray cabinet using a SS11008 Teejet nozzle.

Measurements

Plants in each replicate pot were assessed at 1, 7, 14 and 21 days after treatment (DAT) for percent phytotoxicity (0-100% in 10% increments). Dry weight of above ground biomass per pot was determined 21 DAT.

Results

Results of this experiment (Table 3) indicated that the level of dandelion (Taraxacum officinale Weber) suppression increased with the increasing level of natural herbicide in both formulations. Increasing level of crabgrass (Digitaria spp) suppression were only achieved with Compound I. The lowest effective rate for crabgrass control is 40×LPLC purified Compound I. Results also indicated that crabgrass is highly susceptible to Compound I whereas dandelion is susceptible to Compound I plus Compound II. Little or no damage to Kentucky blue grass treated with the tested natural herbicides was noticed.

TABLE 3
Dry weight reduction of dandelion and crabgrass seedlings 21 days after
treatment with Compound I or Compound I and Compound II produced by
Burkholderia andropogonis

| | | Weed species | | | | | |
|---|---|---|---|---|---|---|---|
| | | | | | | Kentucky blue | |
| | | Dandelion | | Crabgrass | | grass | |
| | | Application rate (L/ha) | | | | | |
| | | 800 | 1600 | 800 | 1600 | 800 | 1600 |
| Formulation | Concentration | Dry Weight Reduction (%) | | | | | |
| Cell-free | 10x | 20.71a | 50.40bc | 0a | 26.62a | 4.88a | 0a |
| culture filtrates | 12.5x | 49.33bc | 36.40a | 24.58a | 22.53a | 16.41a | 0a |
| (Compound I | 15x | 56.13bc | 52.47bc | 0a | 6.76a | 0a | 0a |
| and Compound | 17.5x | 65.39cd | 59.31cd | 0a | 0a | 8.38a | 0.18a |
| II) | 20x | 74.94d | 70.25cd | 0a | 66.47b | 11.85a | 0a |
| Compound I | 10x | 12.38ab | 24.72b | 0a | 42.03c | 4.75a | 26.61b |
| | 20x | 54.66c | 49.37c | 29.25bc | 80.89d | 0a | 0a |
| | 40x | 51.87c | 64.59c | 83.39d | 92.09d | 0a | 0a |

a, b, c, d, Values followed by the same letter are not significantly different according to t-test (P ≧ 0.1)

### Example 7

### Field Efficacy

A small-scale field trial was conducted in the summer of 2004 at the Alberta Research Council in Vegreville Alberta. The efficacy of Compound I plus Compound II in the formulation of 10× filtrates of Burkholderia andropogonis, isolate CW00B006C, was tested on seedling dandelion (Taraxacum officinale Weber) in comparison to the commercial herbicide, Killex (Green Cross Killex Concentrate, Scotts Canada Ltd.).

Experimental Design

The experiment was a randomized complete block design with 4, 1 m², replicate plots per treatment. Dandelion seedlings were at the 8-leaf growth stage at a density of approximately 40 seedling dandelions (Taraxacum officinale Weber) per plot when spray treatment was applied. Ten sample plants per plot were randomly selected and numbered prior to treatment.

Treatments

Treatments included Compound I plus Compound II, Killex (Green Cross Killex Concentrate, Scotts Canada Ltd.), and a control (no spray). Compound I plus Compound II in the formulation of 10× cell free culture filtrates were prepared as previously described (Example 1), with addition of 0.15% Silwet L-77 v/v just prior to spray application. Killex (Green Cross Killex Concentrate, Scotts Canada Ltd.) herbicide was prepared to the manufactures recommendations of 6 ml of Killex (Green Cross Killex Concentrate, Scotts Canada Ltd.) per liter. All spray applications were preformed with a hand-held compressed air sprayer at a spray volume of 2000 L/ha.

Measurements

The ten, numbered dandelion (Taraxacum officinale Weber) plants per replicate plot were assessed at 0, 4, 7, 14 and/or 21 days after treatment (DAT). Assessment parameters for each plant included percent phytotoxicity (0-100% in 10% increments), leaf number, plant diameter, and dry weight.

Data Analysis

All statistical analyses were performed using SAS Release 8.2 for Windows. Statistical procedures were selected based on the distribution of the data and the validity of the assumptions. Only data for dry weight was transformed (log transformation) in order to normalize the data prior to analysis. Transformation of other parameters did not aid in normalization and untransformed data was therefore used. All analyses included a control treatment group. All analyses were conducted at P≦0.05. Diameter, percent phytotoxicity, and leaf number were analyzed using a repeated measures analysis of variance. The model contained treatment DAT (4, 7, 14, and 21 DAT as available) and treatment by DAT interaction as fixed effects. The repeated measures analysis technique used was either equal (diameter and leaf number) or unequally spaced (percent phytotoxicity) depending on the days data was collected for the parameter. Values for 0 DAT (pre-treatment) as well as the final dry weights were compared between treatments using the analysis of variance for a randomized complete block design. Data for 0 DAT was included as a covariate for diameter, percent phytotoxicity, and leaf number. For all analyses, the model revealed a statistical significance (P≦0.05), Tukey-Kramer adjusted comparisons were used to determine if pairwise differences existed between groups.

Results

Both Compound I plus Compound II and Killex (Green Cross Killex Concentrate, Scotts Canada Ltd.) treated plants demonstrated severe symptoms clearly visible at 4 DAT and symptoms continued to progress until 7-14 DAT (FIG. 5). Symptoms on Compound I plus Compound II treated dandelion (Taraxacum officinale Weber) included necrosis and death of older leaves, stunting, chlorosis of new growth, and small, distorted new leaves.

In general, control plants were significantly larger in diameter, had more leaves and were healthier than Killex (Green Cross Killex Concentrate, Scotts Canada Ltd.) and Compound I plus Compound II treated plants. No significant difference existed between Killex (Green Cross Killex Concentrate, Scotts Canada Ltd.) and Compound I plus Compound II for average rating or average diameter. Leaf number was significantly higher for the Control than for Compound I plus Compound II, and significantly lower for Killex (Green Cross Killex Concentrate, Scotts Canada Ltd.) than for Compound I plus Compound II overall (FIG. 6).

At 21 DAT, when sample plants were harvested, the dry weight of Compound I plus Compound II and Killex (Green Cross Killex Concentrate, Scotts Canada Ltd.) plants was not significantly different, while both had a significantly lower dry weight than the control treatment (FIG. 7). A 68% reduction in mean dry weight was achieved with Compound I plus Compound II, while a 70% reduction in mean dry weight was achieved with Killex (Green Cross Killex Concentrate, Scotts Canada Ltd.).

All citations are hereby incorporated by reference.

### LITERATURE CITED

Abbas, H. K., Tanaka, T., Duke, S. O. and Boyette, C. D. 1995. Susceptibility of various crop and weed species to AAL-toxin, a natural herbicide. Weed Technology 9: 125-130.

Baldani, V. L. D., Oliveira, E., Balota, E., Baldani, J. I., Kirchjof, G. and Dbereiner, J. 1997. B. brasiliensis sp. nov., uma mova espcie de bactria diazotrfica endoftica. Ann. Acad. Bras. Ci. 69: 116.

Balogh, J. C. and Anderson, J. L. 1992. Environmental impacts of turfgrass pesticides. In: Balogh J. C., Walker W. J. (eds) Golf course management and construction-Environmental issues. Lexis Publishers, Chelsea, pp. 221-354.

Cérantola, S., Lemassu-Jacquier, A. and Montrozier, H. 1999. Structure elucidation of a novel exopolysaccharide produced by a nucoid clinical isolate of Burkholderia cepacia. Characterization of a trisubstituted glucuronic acid residue in a heptasaccharide repeating unit. Eur. J. Biochem. 260: 373-383.

Cescutti, P., Bosco, M., Picotti, F., Impallomeni, G., Leitao, J. H., Richau, J. A. and Sá-Correia, I. 2000. Structure study of the exopolysaccharide produced by a clinical isolate of Burkholderia cepacia. Biochem. Biophys. Res. Commun. 273: 1088-1094.

Duke, S. O., Dayan, F. E., Romagni, J. G. and Rimando, A. M. 2000. Natural products as sources of herbicides: current status and future trends. Weed Research. Blackwell Science Ltd. 40: 99-111.

Gillis, M., Van, T. V., Bardin, R., Goor, M., Hebbar, P., Willems, A., Segers, P., Kersters, K., Heulin, T. and Fernandez, M. F. 1995. Polyphasic taxonomy in the genus Burkerholderia leading to an emended description of the genus and proposition of Burkholderia vietnamiensis sp. Nov. for N2-fixing isolates from rice in Vietnam. Int. J. Syst. Bacteriol. 45: 274-289.

Govan, J. R. W. and Deretic, V. 1996. Microbial pathogenesis in cystic fibrosis: mucoid Pseudomonas aeruginosa and Burkholderia cepacia. Microbiol. Rev. 60: 539-574.

Hoitink, H. A. J., and S. L. Sinden. 1970. Partial purification and properties of chlorosis inducing toxins of Pseudomonas phaseolicola and Pseudomonas glycinea. Phytopathol. 60: 1236-1237.

Kuykendall, L. E., Saxena, B. Devine, T. E. and Udell, S. E. 1992. Genetic diversity in Bradyrhizobium japonicum Jordan 1982 and a proposal for Bradyrhizobium elkanii sp. nov. Can. J. Microbiol. 38: 501-505.

Leigh, J. A. and Coplin, D. L. 1992. Exopolysccharides in plant-bacterial interactions. Annu. Rev. Microbiol. 46: 307-346.

Lydon, J. and Duke S. O. 1999. Inhibitors of glutamine biosynthesis. In: Plant Amino Acids: Biochemistry and Biotechnology (ed. BK Singh), 445-464. Marcel Dekker, New York, USA.

Mattos, K. A., Jones, C., Heise, N., Previato, J. O. and Mendonca-Preuato, L. 2001. Structure of an acidic exopolysaccharide produced by the diazotrophic endophytic bacterium Burkholderia brasiliensis. Eur.J. Biochem. 268: 3174-3179.

Mitchell, R. E., Frey, E. J. and Benn, M. K. 1986. Rhizobitoxine and 1-threo-hydroxythreonine production by the plant pathogen Pseudomonas andropogonis. Phytochemistry 25: 2711-2715.

Mitchell, R. E., and Frey, E. J. 1988. Rhizobitoxine and hydroxythreonine production by Pseudomonas andropogonis strains, and the implications to plant disease. Physiol. Mol. Plant Pathol. 32:355-341.

Nakajima, M., Itoi, K. and Takamatsu, Y. 1989. Cornexistin: a new fungal metabolite with herbicidal activity. Journal of Antibiotics 42: 1065-1072.

Nakajima, M. Itoi, K. and Takamatsu, Y. 1991. Hydantocidin: a new compound with herbicidal activity. Journal of Antibiotics. 44: 293-300.

Owens, L. D. and Wright, D. A. 1965. Rhizobial-induced chlorosis in soybeans: isolation, purification in nodules, and varietal specificity of the toxin. Plant Physiol. 40: 927-930.

Owens, L. E., Thompson, J. F., Pitcher, R. G. and Fennessy, P. V. 1972. Dihydrorhizobitoxine, a new ether amino-acid from Rhizobium japonicum. J. Chem. Soc. Chem. Commun. 1972:715.

Owens, L. E. 1973. Herbicidal potential of rhizobitoxine. Weed Sci. 21(1): 63-66.

Parks, L. C. 1993. Handbook of Microbiological Media. CRC Press, Inc., Boca Raton, Fla. Pg. 438.

Steinmetz, I., Rhode, M. and Brenneke, B. 1995. Purification and characterization of an exopolysacchride of Burkholeria (pseudomonas) pseudomallei. Infec. Immun. 63: 3959-3965.

The present invention has been described with regard to one or more embodiments. However, it will be apparent to persons skilled in the art that a number of variations and modifications can be made without departing from the scope of the invention as defined in the claims.

What is claimed is:

1. A natural herbicide comprising a Burkholderia species cell-free culture fraction having herbicidal activity and a molecular weight less than about 5000 Daltons.

2. The natural herbicide of claim 1, wherein said fraction has a molecular weight of less than about 1000 Daltons.

3. The natural herbicide of claim 1, wherein the Burkholderia species is Burkholderia andropogonis, isolate CW00B006C.

4. The natural herbicide of claim 1, wherein said fraction is a substantially purified compound having a molecular weight of about 180 Daltons to about 200 Daltons.

5. The natural herbicide of claim 4, wherein said substantially purified compound has a molecular weight of about 192 Daltons.

6. The natural herbicide of claim 1, wherein said fraction is a substantially purified compound having a molecular weight of about 380 Daltons to about 400 Daltons.

7. The natural herbicide of claim 6, wherein said substantially purified compound has a molecular weight of about 390 Daltons.

8. The natural herbicide of claim 7, wherein said purified compound comprises a glycolipid.

9. The natural herbicide of claim 8, wherein said glycolipid has the formula C₂₀H₃₈O₇.

10. A herbicidal composition comprising the natural herbicide of claim 1 and a suitable adjuvant.

11. The herbicidal composition of claim 10, wherein the adjuvant is a surfactant.

12. The herbicidal composition of claim 11, wherein the surfactant is Silwet L-77.

13. A method of suppressing or controlling growth of a target plant comprising applying a composition comprising the natural herbicide of claim 1 to the target plant.

14. The method of claim 13, wherein the target plant is a member of a genus selected from the group of Taraxacum, Trifolium, Medicago, Companula, Bellis, Plantago, Cynodon, Poa, and Digitaria.

15. A method of suppressing or controlling growth of a target plant comprising applying the composition of claim 10 to the target plant.

16. The method of claim 15, wherein the target plant is a member of a genus selected from the group of Taraxacum, Trifolium, Medicago, Companula, Bellis, Plantago, Cynodon, Poa, and Digitaria.

17. A method of producing a natural herbicide comprising, obtaining a cell-free culture conditioned by growth of a Burkholderia species, fractionating the cell-free culture to obtain a fraction having herbicidal activity, and purifying the fraction having herbicidal activity to produce the natural herbicide.

18. The method of claim 17, wherein the Burkholderia species is Burkholderia andropogonis isolate CW00B006C.

19. The method of claim 18, wherein the natural herbicide has a molecular mass of about 192 Daltons.

20. The method of claim 19, wherein the natural herbicide has a molecular mass of about 390 Daltons.
